(19) United States
(12) Patent Application Publication
(10) Pub. No.: US 2009/0317709 A1
(43) Pub. Date: Dec. 24, 2009

(54) COMPOSITE CARBON FOAM

(75) Inventors: Nicholas Brazis, Naperville, IL (US); Kurtis C. Kelley, Washington, IL (US); Matthew J. Maroon, Metamora, IL (US); Boris I. Monahov, East Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Firefly Energy Inc., Petoria, IL (US)

(21) Appl. No.: 12/377,816

(22) PCT Filed: Aug. 18, 2006
(86) PCT No.: PCT/US06/32366

§ 371 Date: May 14, 2009

(51) Int. Cl. H01M 2/02; H01B 1/04; B05D 5/12; H01B 1/12

(52) U.S. Cl. 429/163; 252/502; 427/113; 252/511

(57) ABSTRACT

A composite foam including a carbon foam material comprising a network of pores and a plurality of discontinuities and a secondary material deposited on at least some of the plurality of discontinuities of the carbon foam material.

### TECHNICAL FIELD

The present invention relates to composite materials and, more particularly, to an electrically-conductive composite carbon foam.

### BACKGROUND

Electrochemical batteries, including, for example, lead acid and nickel-based batteries, among others, are known to include at least one positive current collector, at least one negative current collector, and an electrolytic solution. In traditional lead acid batteries, for example, both the positive and negative current collectors are constructed from lead. The role of these lead current collectors is to transfer electric current to and from the battery terminals during the discharge and charging processes. Storage and release of electrical energy in lead acid batteries is enabled by chemical reactions that occur in a paste disposed on the current collectors. The positive and negative current collectors, once coated with this paste, are referred to as positive and negative plates, respectively. A notable limitation on the durability of lead-acid batteries is corrosion of the lead current collector of the positive plate.

The rate of corrosion of the lead current collector is a major factor in determining the life of the lead acid battery. Once the electrolyte (e.g., sulfuric acid) is added to the battery and the battery is charged, the current collector of each positive plate is continually subjected to corrosion due to its exposure to sulfuric acid and to the anodic potentials of the positive plate. One of the most damaging effects of this corrosion of the positive plate current collector is volume expansion. Particularly, as the lead current collector corrodes, lead dioxide is formed from the lead source metal of the current collector. Moreover, this lead dioxide corrosion product has a greater volume than the lead source material consumed to create the lead dioxide. Corrosion of the lead source material and the ensuing increase in volume of the lead dioxide corrosion product is known as volume expansion.

Volume expansion induces mechanical stresses on the current collector that deform and stretch the current collector. At a total volume increase of the current collector of approximately 4 percent to 7 percent, the current collector may fracture. As a result, battery capacity may drop, and eventually, the battery will reach the end of its service life. Additionally, at advanced stages of corrosion, internal shorting within the current collector and rupture of the cell case may occur. Both of these corrosion effects may lead to failure of one or more of the cells within the battery.

One method of extending the service life of a lead acid battery is to increase the corrosion resistance of the current collector of the positive plate. Several methods have been proposed for inhibiting the corrosion process in lead acid batteries. Because carbon does not oxidize at the temperatures at which lead-acid batteries generally operate, some of these methods have involved using carbon in various forms to slow or prevent the detrimental corrosion process in lead acid batteries. For example, in U.S. Patent Publication No. 20040121238 carbon foam has been proposed as a current collector material for use in lead acid batteries. Use of carbon foam (e.g., graphite foam) as a current collector can increase the corrosion resistance and surface area of the current collector over lead current collector grids. This additional surface area of the current collectors may increase the specific energy and power of the battery, thereby enhancing its performance. However, among the network of pores formed in the foam, there may exist a plurality of discontinuities that may allow intercalation of electrically charged ions into the structure of the foam. These ions can act like a wedge being driven within the carbon foam structure causing internal damage (e.g., cracking and separation) and leading to premature failure of the current collector. The effects of intercalation may be particularly prevalent when the carbon foam structure includes graphite. Further, discontinuities can provide reaction sites that promote chemical interaction between the carbon foam and various chemically reactive species. This chemical interaction can compromise the structural integrity of the carbon foam. The chemical reactivity may have destructive effects on many types of carbon foams.

The present invention is directed to overcoming one or more of the problems or disadvantages existing in the prior art.

### SUMMARY OF THE INVENTION

Apparatus and methods of the present invention relate to an electrically conductive composite carbon foam.

One embodiment of the disclosure includes a composite foam. The composite foam includes a carbon foam material including a network of pores and a plurality of discontinuities. The composite foam further includes a secondary material selectively deposited on or within at least some of the plurality of discontinuities of the carbon foam material in an amount between about 0.5 percent by weight or greater and less than 25 percent by weight of the composite foam.

In another embodiment, an electrically conductive composite foam is disclosed. The electrically conductive composite foam includes a carbon foam material including a network of pores and a plurality of discontinuities, wherein the carbon foam has a resistivity value no greater than 50,000 micro ohm-cm. The electrically conductive composite foam further includes a secondary material selectively deposited on at least some of the plurality of discontinuities of the carbon foam material.

In yet another embodiment, a lead acid battery is disclosed. The lead acid battery includes a housing, at least one cell disposed within the housing, an electrolyte, and at least one electrically conductive component including a composite foam material. The composite foam material includes a carbon foam material comprising a network of pores and a plurality of discontinuities and a secondary material deposited on or within at least some of the plurality of discontinuities of the carbon foam material.

In yet another embodiment, a method for producing a composite foam is disclosed. The method includes the step of providing a treatment mixture, including a secondary material and a substantially polar solvent, wherein the secondary material maintains an electrical charge of a first polarity. The method further includes the steps of exposing a carbon foam material, including a network of pores and a plurality of discontinuities, to the treatment mixture, and applying a voltage potential of a second polarity to the carbon foam material, wherein the second polarity is opposite to the first polarity.

In yet another embodiment, a method for reinforcing a composite foam component is disclosed. The method includes the steps of providing a treatment mixture comprising a secondary material and a solvent and exposing a carbon foam material comprising a network of pores and a plurality of discontinuities to the treatment mixture, wherein exposing the carbon foam material to the treatment mixture effects a transfer of at least some of the secondary material to the carbon foam material such that the secondary material is selectively deposited on or within at least some of the plurality of discontinuities in an amount of about 0.5 percent by weight or greater and less than 25 percent by weight of the composite foam.

### BRIEF DESCRIPTION OF THE DRAWINGS

The accompanying drawings, which are incorporated in and constitute a part of this specification, illustrate embodiments of the invention and together with the description, serve to explain the principles of the invention. In the drawings:

FIG. 1 illustrates a battery 10 in accordance with an exemplary embodiment of the present invention;

FIG. 2A illustrates a current collector 20 according to an exemplary embodiment of the present invention;

FIG. 2B illustrates a closer view of tab 21, which optionally may be formed on current collector 20;

FIG. 3 provides a two-dimensional representation, at approximately 100× magnification, of an exemplary carbon foam;

FIG. 4 is a flow diagram depicting an exemplary method for treating a carbon foam with a secondary material consistent with an embodiment of the present invention; and

FIG. 5 is a flow diagram depicting another exemplary method for treating a carbon foam with a secondary material consistent with an embodiment of the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

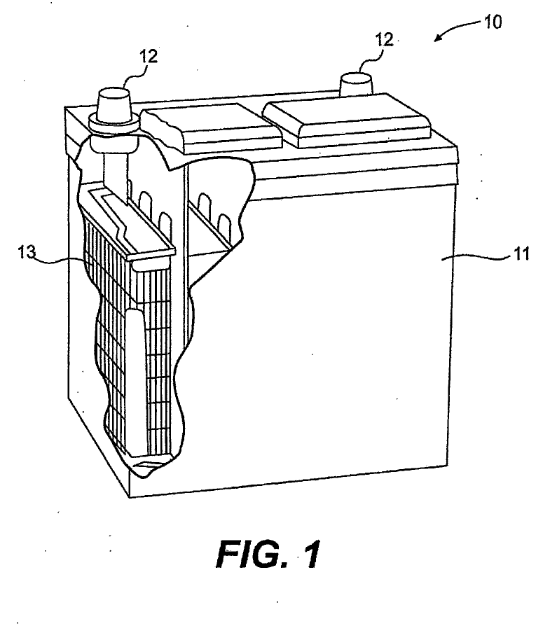

FIG. 1 illustrates a battery 10 in accordance with an exemplary embodiment of the present invention. Battery 10 includes a housing 11 and terminals 12, which may be external to housing 11. At least one cell 13, is disposed within housing 11. Battery 10 may operate with a single cell 13, or alternatively, multiple cells may be connected in series or in parallel to provide a desired total potential of battery 10.

Each cell 13 may be composed of alternating positive and negative plates or electrodes immersed in an electrolytic solution. The electrolytic solution composition may be chosen to correspond with a particular battery chemistry. For example, lead acid batteries may include an acidic electrolytic solution. Any suitable acid may be used to provide the electrolyte of a lead acid battery. In one particular embodiment, sulfuric acid may be mixed with water to provide the electrolyte solution of battery 10. Alternatively, batteries of other chemistries may include other electrolytes. For example, nickel-based batteries may include alkaline electrolyte solutions that include a base (e.g., KOH) mixed with water.

Battery 10 further includes at least one electrically conductive component including, for example, current collectors, bus bars, and any other electrically conductive component consistent with the present invention. In one embodiment, the positive and negative plates of each cell 13 may include an electrically conductive current collector packed or coated with a chemically active material. The composition of the chemically active material may depend on the chemistry of battery 10. For example, lead acid batteries may include a chemically active material including, for example, an oxide or salt of lead. Further, the anode plates (i.e., positive plates) of nickel cadmium (NiCd) batteries may include cadmium hydroxide (Cd(OH)₂) material; nickel metal hydride batteries may include lanthanum nickel (LaNi₅) material; nickel zinc (NiZn) batteries may include zinc hydroxide (Zn(OH)₂) material; and nickel iron (NiFe) batteries may include iron hydroxide (Fe(OH)₂) material. In all of the nickel-based batteries, the chemically active material on the cathode (i.e., negative) plate may be nickel hydroxide.

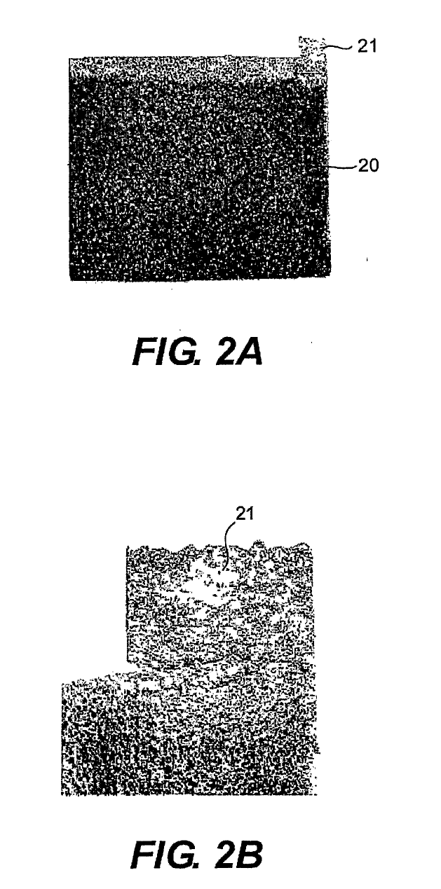

FIG. 2A illustrates a current collector 20 according to an exemplary embodiment of the present invention. Current collector 20 may include a thin, rectangular body and a tab 21 used to form an electrical connection with current collector 20. Tab 21, however, may be omitted in some embodiments.

The current collector shown in FIG. 2A may be used to form either a positive or a negative plate. As previously stated, chemical reactions in the active material disposed on the current collectors of the battery enable storage and release of energy. The composition of this active material, and not the current collector material, determines whether a given current collector functions as either a positive or a negative plate.

While the type of plate, whether positive or negative, does not depend on the material selected for current collector 20, the current collector material and configuration can affect the characteristics and performance of battery 10. For example, during the charging and discharging processes, each current collector 20 transfers the resulting electric current to and from battery terminals 12. In order to efficiently transfer current to and from terminals 12, current collector 20 may be formed from a conductive material. Further, the susceptibility of the current collector material to corrosion may affect not only the performance of battery 10, but it can also impact the service life of battery 10. In addition to the material selected for the current collector 20, the configuration of current collector 20 can also be important to battery performance. For instance, the amount of surface area available on current collector 20 may influence the specific energy, specific power, and the charge/discharge rates of battery 10.

In an exemplary embodiment of the present invention, current collector 20, as shown in FIG. 2A, is formed from a carbon foam material, which may include carbon or carbon-based materials that exhibit some degree of porosity. In certain embodiments, the carbon may include graphite foam. Because the foam is carbon, it can resist corrosion even when exposed to electrolytes and to the electrical potentials of the positive or negative plates. Further, current collectors composed of carbon foam may exhibit more than 2000 times the amount of surface area provided by conventional current collectors.

The disclosed foam material may include any carbon-based material including a three-dimensional network of struts and pores. The foam may comprise either or both of naturally occurring and artificially derived materials.

FIG. 2B illustrates a closer view of tab 21, which optionally may be formed on current collector 20. Tab 21 may be coated with a conductive material and used to form an electrical connection with the current collector 20. In addition to tab 21, other suitable configurations for establishing electrical connections with current collector 20 may be used. The conductive material used to coat tab 21 may include a metal that is more conductive than the carbon foam current collector. Coating tab 21 with a conductive material may provide structural support for tab 21 and create a suitable electrical connection capable of handling the high currents present in a lead acid and nickel-based batteries.

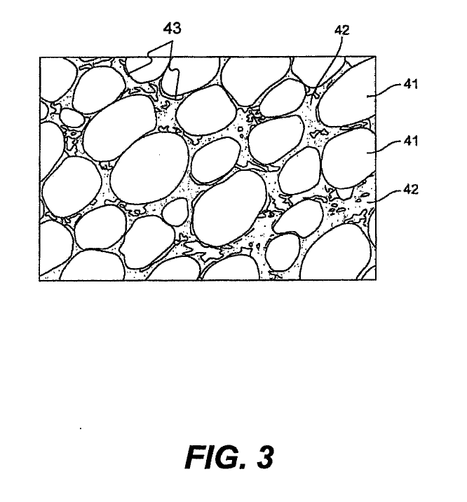

FIG. 3 provides a two-dimensional representation, at approximately 100× magnification, of an exemplary carbon foam. The carbon foam may include a network of pores 41. These pores provide a large amount of surface area for each current collector 20. The carbon foam may further include discontinuities 43. The term “discontinuity” as used herein shall be understood to mean any openings, cracks, steps, fissures, separations, chasms, apertures, or perforations within the solid structure of the carbon foam material. Discontinuities may be readily apparent or substantially indiscernible when viewed with the naked eye or under a microscope. Further, discontinuities may vary in size, shape, and structure. For example, a discontinuity may include a hairline crack on the walls of a pore or a chasm-like separation between sheets of graphite within the foam, among others.

In one embodiment, the carbon foam may include from about 4 to about 50 pores per centimeter and an average pore size of at least about 200 micrometers. In other embodiments, however, the average pore size may be smaller. For example, in certain embodiments, the average pore size may be at least about 40 micrometers. In still other embodiments, the average pore size may be at least about 20 micrometers. While reducing the average pore size of the carbon foam material may have the effect of increasing the effective surface area of the material, average pore sizes below 20 micrometers may impede or prevent penetration of the chemically active material into pores of the carbon foam material.

Regardless of the average pore size, a total porosity value for the carbon foam may be at least 60 percent. In other words, at least 60 percent of the volume of the carbon foam structure may be included within pores 41. Carbon foam materials may also have total porosity values less than 60 percent. For example, in certain embodiments, the carbon foam may have a total porosity value of at least 30 percent.

Moreover, the carbon foam may have an open porosity value of at least 90 percent. Therefore, at least 90 percent of pores 41 are open to adjacent pores such that the network of pores 41 forms a substantially open network. This open network of pores 41 may allow the active material deposited on each current collector 20 to penetrate within the carbon foam structure. In addition to the network of pores 41, the carbon foam includes a web of structural elements 42 that provide support for the carbon foam. In total, the network of pores 41 and the structural elements 42 of the carbon foam may result in a density of less than about 0.6 gm/cm³ for the carbon foam material.

Due to the conductivity of the carbon foam of the present invention, current collectors 20 can efficiently transfer current to and from battery terminals 12, or any other conductive elements providing access to the electrical potential of battery 10. In certain forms, the untreated carbon foam may offer sheet resistivity values of less than about 1 ohm-cm. In still other forms, the untreated carbon foam may have sheet resistivity values of less than about 0.75 ohm-cm.

In one embodiment, the carbon foam may be a graphite foam used to form current collector 20. One such graphite foam, under the trade name PocoFoam™, is available from Poco Graphite, Inc. The density and pore structure of graphite foam may be similar to carbon foam. A primary difference between graphite foam and carbon foam is the orientation of the carbon atoms that make up the structural elements 42. For example, in carbon foam, the carbon may be at least partially amorphous. In graphite foam, however, more of the carbon is ordered into a graphite, layered structure. Because of the ordered nature of the graphite structure, graphite foam may offer higher conductivity than carbon foam. Untreated graphite foam may exhibit electrical resistivity values of between about 100 micro-ohm-cm and about 2,500 micro-ohm-cm. In some cases, graphite foams may approach resistivity values up to 50,000 micro-ohm-cm.

The carbon and graphite foams of the present invention may also be obtained by subjecting various organic materials to a carbonizing and/or graphitizing process. In one exemplary embodiment, various wood species may be carbonized and/or graphitized to yield the carbon foam material for current collector 20. Wood includes a natural occurring network of pores. These pores may be elongated and linearly oriented. Moreover, as a result of their water-carrying properties, the pores in wood form a substantially open structure. Certain wood species may offer an open porosity value of at least about 90 percent. The average pore size of wood may vary among different wood species, but in an exemplary embodiment of the invention, the wood used to form the carbon foam material has an average pore size of at least about 20 microns.

Many species of wood may be used to form the carbon foam of the invention. As a general class, most hardwoods have pore structures suitable for use in the carbon foam current collectors of the invention. Optionally, the wood selected for use in creating the carbon foam may originate from tropical growing areas. For example, unlike wood grown in climates with significant seasonal variation, wood from tropical regions may have a less defined growth ring structure. As a result, the porous network of wood from tropical areas may lack certain non-uniformities that can result from the presence of growth rings. Exemplary wood species that may be used to create the carbon foam include oak, mahogany, teak, hickory, elm, sassafras, bubinga, palms, and many other types of wood.

To provide the carbon foam, wood may be subjected to a carbonization process to create carbonized wood (e.g., a carbon foam material). For example, heating of the wood to a temperature of between about 800 degrees C. and about 1400 degrees C. may have the effect of expelling volatile components from the wood. The wood may be maintained in this temperature range for a time sufficient to convert at least a portion of the wood to a carbon matrix. This carbonized wood will include the original porous structure of the wood. As a result of its carbon matrix, however, the carbonized wood can be electrically conductive and resistant to corrosion. During the carbonization process, the wood may be heated and cooled at any desired rate. In one embodiment, however, the wood may be heated and cooled sufficiently slowly to minimize or prevent cracking of the wood/carbonized wood. Also, heating of the wood may occur in an inert environment.

The carbonized wood may be used to form current collectors 20 without additional processing. Optionally, however, the carbonized wood may be subjected to a graphitization process to create graphitized wood (e.g., a graphite foam material). Graphitized wood is carbonized wood in which at least a portion of the carbon matrix has been converted to a graphite matrix. As previously noted, the graphite structure may exhibit increased electrical conductivity as compared to non-graphite carbon structures. Graphitizing the carbonized wood may be accomplished by heating the carbonized wood to a temperature of between about 2400 degrees C. and about 3000 degrees C. for a time sufficient to convert at least a portion of the carbon matrix of the carbonized wood to a graphite matrix. Heating and cooling of the carbonized wood may proceed at any desired rate. In one embodiment, however, the carbonized wood may be heated and cooled sufficiently slowly to minimize or prevent cracking. Also, heating of the carbonized wood may occur in an inert environment.

Discontinuities 43 may be of variable shapes and sizes and exist at numerous areas and at random intervals throughout the carbon foam structure. Discontinuities 43 may allow intercalation of electrically charged ions and may also create multiple reactive sites on a carbon foam structure for chemical attack, among other things. Particularly, an untreated graphite foam may experience destructive intercalation of electrically charged ions via discontinuities 43 when exposed to certain chemical environments (e.g., those present in a lead-acid battery) and absent any treatment of discontinuities 43. For example, when coated with an active material and utilized as a current collector in a battery, the untreated graphite foam structure may experience forces much like a wedge driving the layered graphite structure apart. The electrically charged nature of the current collector attracts the ions and causes them to be drawn deeper inside discontinuities 43 causing further damage.

Additionally, surfaces of discontinuities 43 provide a large number of reactive areas whereby reactive chemicals may work to break down underlying carbon structure. Such forces may cause additional cracking resulting in an increase in discontinuities 43 thereby leading to additional chemically reactive sites and, in the case of graphite, additional intercalation. Ultimately, these forces may eventually lead to complete destruction of the conductive path through the foam, which can mark the failure of a current collector.

To minimize intercalation, reduce reactive area, and/or add additional structural reinforcement to an electrically conductive carbon foam, treatment with a secondary material may be performed, resulting in a composite carbon foam. For example, a secondary material may be deposited on a carbon foam structure, particularly on and around discontinuities 43, to substantially close, or limit the open area associated with discontinuities 43. By concentrating the secondary material on and around discontinuities 43, discontinuities 43 may become substantially covered or sealed, thereby creating physical restraint and impeding intercalation of the charged ions while also reducing the available reactive area. The remaining surface area of the carbon foam (e.g., including areas with few or no discontinuities) may remain substantially uncovered by the secondary material. Because discontinuities 43 may also create areas of concentrated physical stress, providing additional support in such areas may also have the beneficial effect of enhancing the structural integrity of the carbon foam.

In one embodiment consistent with the present invention, the secondary material used for treatment of a carbon foam may include non-conductive materials such as polymers and glasses. For example, the secondary material may include a polymer such as polyvinylalanine or polycarbonates. However, the secondary material may include any suitable polymer such as, for example, polyethylene, polypropylene, polystyrene, Teflon, urethane, polyesters, polyvinylpyrollidone, polyvinylchloride, or any other suitable thermoplastic or thermoset material known in the art. In another embodiment, the secondary material may include, for example, a phosphate glass, a silicate glass, or other similarly derived material. One of skill in the art will recognize that numerous other suitable materials may also be used as a secondary material while remaining within the scope of the invention.

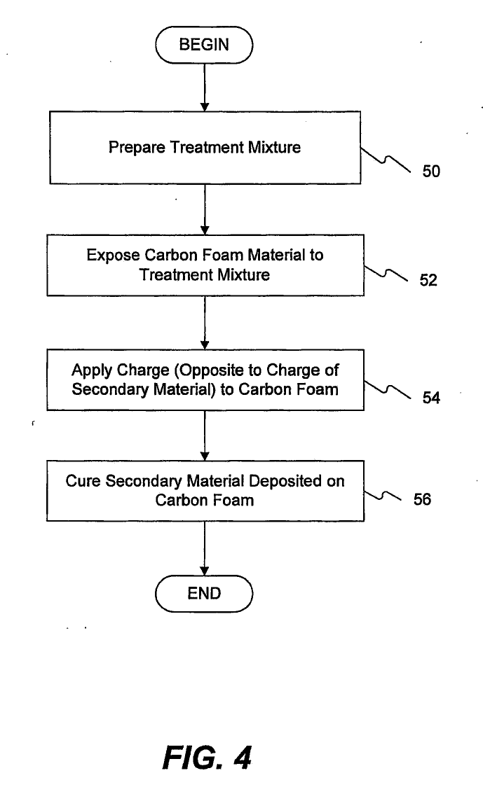

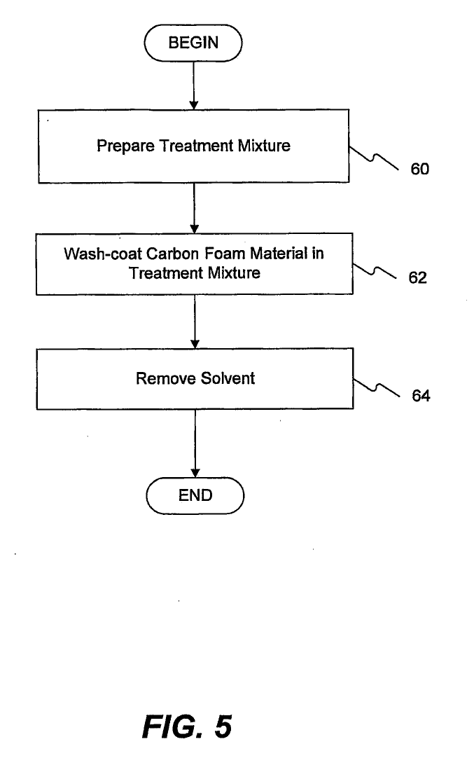

In one example consistent with the present invention, a secondary material may be deposited on a carbon foam structure in an amount of about 0.5 percent by weight or greater and less than 25 percent by weight of the composite foam. In such an embodiment, and using treatment methods discussed in greater detail with reference to FIGS. 4 and 5, the secondary material may be concentrated on discontinuities 43. Surfaces of structural elements 42 and pores 41 of the carbon foam may remain substantially free of secondary material while discontinuities 43 may be substantially covered. In such an embodiment, the weight increase of the composite foam can be minimized, which may provide beneficial energy to weight ratio when the foam is utilized within a lead acid battery.

FIG. 4 is a flow diagram depicting an exemplary method for treating a carbon foam with a secondary material. To apply a secondary material to a carbon foam structure, a treatment mixture suitable for exposing the carbon foam to the secondary material may be prepared (step 50). The term “mixture” as used herein may encompass any combination of a solvent and secondary materials (solids or liquids) resulting in a slurry, solution, emulsion, suspension, or colloidal preparation. The resulting combination (mixture) may be distributed over the surfaces, pores, and discontinuities of a porous and irregularly shaped structure. The term “solvent” as used herein is intended to refer to the portion of any such mixture into which the secondary material is introduced.

Prior to creating a treatment mixture, initial preparation of a secondary material may be performed. For example, in an embodiment where the secondary material is obtained in solid form (e.g., a block), some mechanical crushing or grinding of the material may initially be performed to place the secondary material in a powder-like or granular state. One of skill in the art will recognize that other methods for preparing a secondary material may be used without departing from the scope of the present invention. For example, where a secondary material is obtained in sheets, cutting and/or grinding of the sheets into pieces of a desired size may be performed.

Once the secondary material has been prepared, the secondary material may be added to a solvent in a quantity between about 0.05 percent to 25 percent by weight of the mixture. In one embodiment, the secondary material may be added to the solvent in a quantity between about 0.1 percent to 0.5 percent by weight of the mixture. The resulting treatment mixture may be agitated, stirred, or may be left to combine on its own based on the materials and solvents used as well as time constraints. In one embodiment, the solvent may include a polar solvent such as water. The use of a polar solvent may cause particles of a secondary material to acquire a charge through frictional or other interaction with the polar solvent. This can be useful when applying a voltage potential intended to induce an opposite charge on a carbon foam material for the purposes of attracting secondary material particles. In other embodiments consistent with the present invention, the solvent may also include acetic acid, ammonia, and methanol. One of skill in the art will recognize that other polar solvents may be used without departing from the scope of the present invention.

By adding the secondary material to a polar solvent, particles of the secondary material may develop an electrical charge on their surface. The charge developed by these particles may cause like particles of secondary material to repel one another. This charge may also allow the particles to remain “suspended” in the mixture. The charge developed by the particles of secondary material may be positive or negative and may depend on the polar solvent used as well as the secondary material itself. For example, when materials including polycarbonates, polyvinylalanine, and epoxies are combined with water, the particles of secondary material may develop a positive charge. Alternatively, a surfactant (e.g., Darvon-C or methyl methacrylate) may be added to such a treatment mixture, which may cause the same positively charged particles of secondary material to become surrounded with a negative charge as a result of the surfactant's presence. Other secondary materials may also develop a negative charge when combined with water in the absence of a surfactant. For example, particles of secondary materials including silicates may develop a negative charge when combined with water.

Once the treatment mixture has been prepared, a carbon foam structure may be exposed to the treatment mixture (step 52). In one embodiment, exposure to the treatment mixture may include immersing the carbon foam structure in the mixture such that the entire structure, including pores 41, structural elements 42, and discontinuities 43, may be exposed to the treatment mixture. In such an embodiment, the treatment mixture may be allowed to substantially penetrate the pores 41 and discontinuities 43 present on the carbon foam structure. Alternatively, the carbon foam structure may not be completely immersed but may be bathed in the treatment mixture while maintaining at least a portion of the carbon foam structure above the level of the mixture. One of skill in the art will recognize that many other methods for exposing the carbon foam structure to the treatment mixture may be used. For example, a treatment mixture may be sprayed on, dripped on, shaken on, painted on, electrostatically applied, etc.

While the carbon foam structure is exposed to the treatment mixture, a voltage potential having a polarity opposite to the surface charge acquired by the particles of secondary material in the treatment mixture may be applied to the carbon foam structure (step 54). In response to the applied voltage, the edges of discontinuities 43 present within the foam may exhibit current densities higher than the surrounding foam structure. This is because a discontinuity causes current to flow around its edges due to the broken conductive path that would normally exist in the absence of the discontinuity. This flow causes a concentration of current along the edges of a discontinuity and a reduction in the current density at other areas lying further from the discontinuity. Such a concentration of current surrounding a discontinuity can result in a substantially higher number of the charged secondary material particles being drawn to and deposited on discontinuities 43 with relatively fewer particles being deposited on the remaining surfaces of structural elements 42 of the carbon foam structure.

Application of a non-conductive secondary material consistent with an embodiment of the present invention may be self-limiting. That is, deposition of the secondary material on discontinuities 43 and the carbon foam structure may reduce associated current densities thereby reducing the attractive forces between the carbon foam structure and the charged particles of secondary material. Further, as particles of secondary material are pulled out of the treatment mixture, fewer particles within the treatment mixture may be available for deposition. The amount of secondary material deposited on the carbon foam structure may be related to of the duration of the applied voltage, the magnitude of the applied voltage, the amount of secondary material in the treatment mixture, the transport properties of the treatment mixture, the number and density of discontinuities 43, and the surface area of the carbon foam structure. In certain embodiments, a voltage less than about 5 V (and preferably between 50 mV and about 1.4 V) may be applied to the foam to deposit secondary material substantially on and around discontinuities 43. The duration of the voltage application may vary depending on the surface area of the foam and the coverage desired. Where additional coverage of a particular carbon foam structure with a secondary material is desired, the voltage may be applied for longer durations and/or additional secondary material may be added to the treatment mixture. Conversely, shorter durations of applied voltage and/or less secondary material in the treatment mixture may be used where less coverage is desired.

Once the secondary material has been deposited on the carbon foam structure in a desired amount, the structure may be removed from the treatment mixture and cured (step 56). The need for curing may depend on the particular secondary material selected. For example, an epoxy based secondary material or thermoset polymer may require curing whereas other secondary materials may require minimal or no curing. The term “cure” as used herein is meant to encompass any process whereby a secondary material undergoes a process (physical, chemical, or combination thereof) resulting in a final state and/or shape of the material different from that existing after deposition but before the process.

Curing may involve a heat treatment applied to the carbon foam structure and the secondary material. For example, where a thermoplastic polymer has been selected as the secondary material, heat treatment may involve heating the carbon foam structure (and deposited secondary material) to between about 90 degrees C. and about 300 degrees C. and holding at that temperature for between about 1 to 10 minutes. The thermoplastic polymer when heated may soften, melt, or liquefy thereby allowing the polymer to flow into and around discontinuities 43 in the carbon foam. Upon cooling of the polymer, it may harden in a different shape (due to flow or other factors) and may adhere to the underlying carbon foam structure resulting in a composite carbon foam structure with substantially covered discontinuities and additional structural support. In another embodiment, a glass may be selected as the secondary material. When a glass has been selected as the secondary material, heat treatment may involve heating the carbon foam structure (and deposited secondary material) to between about 180 degrees C. and about 800 degrees C. and holding at that temperature for between about 2 to 6 hours. One of ordinary skill in the art will recognize that curing temperatures and durations may be substantially dependent on the secondary material used.

Curing may also involve exposing the carbon foam structure and secondary material to a reactant. For example, an epoxy based secondary material deposited on a carbon foam may be exposed to a substance designed to effect a hardening of the epoxy. Such exposure may cause the epoxy to undergo a chemical reaction and harden, substantially covering and adhering to discontinuities 43. Exposure to a reactant may be performed through numerous methods, for example, spraying or painting the reactant on to the carbon foam structure and secondary material.

FIG. 5 is a flow diagram depicting another exemplary method for treating a carbon foam with a secondary material. Prior to treating the carbon foam structure with a secondary material, a treatment mixture suitable for exposing the carbon foam to the secondary material may be prepared (step 60).

Prior to creating a treatment mixture, initial preparation of a secondary material may be performed. For example, in an embodiment where the secondary material is obtained in solid form (e.g., a block), some mechanical crushing or grinding of the material may initially be performed to place the secondary material in a powder-like or granular state. One of skill in the art will recognize that other methods for preparing a secondary material may be used without departing from the scope of the present invention. For example, where a secondary material is obtained in sheets, cutting and/or grinding of the sheets into pieces of a desired size may be performed.

Following preparation of a secondary material, a quantity of the prepared secondary material between about 1 percent and 10 percent by weight of the resulting mixture may be added to a substantially non-polar solvent to form a treatment mixture. In one embodiment, the prepared secondary material may be added to the solvent in a quantity between about 4 percent and 6 percent by weight of the resulting mixture. Examples of substantially non-polar solvents may include, xylene, methylene chloride, benzene, ketones, and acetone. One of skill in the art will recognize that numerous other substantially non-polar solvents may be used without departing from the scope of the present invention. Once the secondary material has been added to the non-polar solvent, the mixture may or may not be agitated as desired to produce a prepared treatment mixture.

Following preparation of the treatment mixture, a carbon foam structure may be exposed to the mixture (step 62). Exposure to the mixture may include “wash-coating” or immersing the carbon foam structure in the mixture such that the entire structure is exposed to the mixture followed by removing the carbon foam structure from the mixture. In such an embodiment, the treatment mixture may be allowed to substantially penetrate pores 41 and discontinuities 43 present on the carbon foam structure. Alternatively, the carbon foam structure may be partially immersed in the mixture such that a portion of the structure remains above the level of the mixture. One of skill in the art will recognize that other methods for exposing the carbon foam structure to the treatment mixture may be used. For example, a treatment mixture may be sprayed on, dripped on, shaken on, painted on, etc.

During exposure to the mixture, capillary action associated with discontinuities present on the carbon foam structure may cause larger amounts of the mixture (and secondary material) to be drawn near and into discontinuities 43. This capillary action may promote coverage of discontinuities 43, while minimizing coverage of the surrounding surfaces of structural elements 42. Further, it may be possible to control the amount of secondary material deposited on the carbon foam and discontinuities therein, by varying the time of exposure to the treatment mixture. For example, a carbon foam structure exposed to a mixture containing secondary material in an amount approximately 5 percent by weight, may result in deposition of between about 0.5 percent and 25 percent of secondary material by weight of the resulting composite foam depending on the duration of exposure. Longer exposure may yield greater amounts of secondary material deposited on the carbon foam, whereas shorter exposure durations may result in smaller amounts.

Once the carbon foam structure has been removed from the mixture, the remaining solvent may be removed (e.g., evaporated) leaving the secondary material behind on the composite carbon foam (step 64). In one embodiment consistent with the present invention, volatility of a solvent may be increased, thereby enhancing evaporation, by placing the composite carbon foam in a vacuum or by applying heat to the structure. Heating the composite carbon foam may also perform the secondary process of curing (where desired). Alternatively, a solvent may be allowed to evaporate at a rate based on the standard atmospheric volatility of the solvent. For example, xylene, a highly volatile solvent, may be used as the solvent for the treatment mixture and may be allowed to evaporate under standard atmospheric conditions following treatment. Less volatile solvents may require additional measures to facilitate removal from the composite carbon foam. Further, other methods including, for example, chemical reactions or mechanical methods may be used for removing the solvent from the composite carbon foam.

Following removal of the solvent, where desired, the secondary material may be cured. Curing may involve a heat treatment applied to the carbon foam structure and the secondary material. For example, where a thermoplastic polymer has been selected as the secondary material, heat treatment may involve heating the carbon foam structure (and deposited secondary material) to between about 90 degrees C. and about 300 degrees C. and holding at that temperature for between about 1 to 10 minutes. The thermoplastic polymer when heated may soften, melt, or liquefy thereby allowing the polymer to flow into and around discontinuities 43 in the carbon foam. Upon cooling of the polymer, it may harden in a different shape (due to flow or other factors) and may adhere to the underlying carbon foam structure resulting in a composite carbon foam structure with substantially covered discontinuities and additional structural support. In another embodiment, a glass may be selected as the secondary material. When a glass has been selected as the secondary material, heat treatment may involve heating the carbon foam structure (and deposited secondary material) to between about 180 degrees C. and about 800 degrees C. and holding at that temperature for between about 2 to 6 hours. One of ordinary skill in the art will recognize that curing temperatures and durations may be substantially dependent on the secondary material used.

Curing may also involve exposing the carbon foam structure and secondary material to a reactant. For example, an epoxy based secondary material deposited on a carbon foam may be exposed to a substance designed to effect a hardening of the epoxy. Such exposure may cause the epoxy to undergo a chemical reaction and harden, substantially covering and adhering to discontinuities 43. Exposure to a reactant may be performed through numerous methods, for example, spraying or painting the reactant on to the carbon foam structure and secondary material.

Other materials not mentioned may be used in manufacturing components consistent with the present invention and without departing from the scope and spirit of the invention.

It is intended that the specification and examples be considered as exemplary only, with a true scope and spirit of the invention being indicated by the following claims.

What is claimed is:

1. A composite foam, comprising:
a carbon foam material including a network of pores and a plurality of discontinuities; and
a secondary material selectively deposited on or within at least some of the plurality of discontinuities of the carbon foam material in an amount between about 0.5 percent by weight or greater and less than 25 percent by weight of the composite foam.

2. The composite foam of claim 1, wherein the carbon foam material includes graphite foam.

3. The composite foam of claim 1, wherein the secondary material includes a polymer.

4. The composite foam of claim 3, wherein the secondary material includes a thermoplastic polymer.

5. The composite foam of claim 3, wherein the polymer includes at least one of polyvinylalanine, polystyrene, and polycarbonate.

6. The composite foam of claim 1, wherein the secondary material includes a glass.

7. The composite foam of claim 6, wherein the secondary material includes at least one of a phosphate glass and a silicate glass.

8. The composite foam of claim 1, wherein at least some surfaces of structural elements defining the network of pores are substantially free of secondary material.

9. The composite foam of claim 1, wherein the composite foam has a resistivity value no greater than 50,000 micro-ohm-cm.

10. The composite foam of claim 1, wherein the composite foam comprises wood.

11. An electrically conductive composite foam, comprising:
a carbon foam material comprising a network of pores and a plurality of discontinuities, wherein the carbon foam has a resistivity value no greater than 50,000 micro-ohm-cm; and
a secondary material selectively deposited on or within at least some of the plurality of discontinuities of the carbon foam material.

12. The electrically conductive composite foam of claim 11, wherein the carbon foam material includes graphite foam.

13. The electrically conductive composite foam of claim 11, wherein the secondary material includes a polymer.

14. The electrically conductive composite foam of claim 13, wherein the secondary material includes a thermoplastic polymer.

15. The electrically conductive composite foam of claim 13, wherein the polymer includes at least one of polyvinylalanine, polystyrene, and polycarbonate.

16. The electrically conductive composite foam of claim 11, wherein the secondary material includes a glass.

17. The electrically conductive composite foam of claim 16, wherein the secondary material includes least one of a phosphate glass and a silicate glass.

18. The electrically conductive composite foam of claim 11, wherein at least some surfaces of structural elements defining the network of pores are substantially free of secondary material.

19. A lead acid battery, comprising:
a housing;
at least one cell disposed within the housing;
an electrolyte; and
at least one electrically conductive component including a composite foam material, comprising:
a carbon foam material comprising a network of pores and a plurality of discontinuities; and
a secondary material deposited on at least some of the plurality of discontinuities of the carbon foam material.

20. The lead acid battery of claim 19, wherein the at least one electrically conductive component comprises a current collector.

21. The lead acid battery of claim 20, further comprising a chemically active paste disposed upon the composite foam material such that the chemically active paste penetrates at least some of the pores of the carbon foam material.

22. The lead acid battery of claim 19, wherein the electrolyte includes an acidic solution.

23. The lead acid battery of claim 22, wherein the acidic solution includes sulfuric acid.

24. The lead acid battery of claim 19, wherein the carbon foam material includes graphite foam.

25. The lead acid battery of claim 19, wherein the secondary material is disposed on the composite foam material in an amount between about 0.5 percent by weight and less than 25 percent by weight of the composite foam material.

26. The lead acid battery of claim 19, wherein the resistivity of the composite foam material is not greater than 50,000 micro-ohm-cm.

27. A method for producing a composite foam, the method comprising:
providing a treatment mixture, including a secondary material and a substantially polar solvent, wherein the secondary material maintains an electrical charge of a first polarity;
exposing a carbon foam material, including a network of pores and a plurality of discontinuities, to the treatment mixture; and
applying a voltage potential of a second polarity to the carbon foam material, wherein the second polarity is opposite to the first polarity.

28. The method of claim 27, wherein the carbon foam material includes graphite foam.

29. The method of claim 27, wherein the substantially polar solvent includes at least one of water, ammonia, methanol, and acetic acid.

30. The method of claim 27, wherein the first polarity is positive.

31. The method of claim 27, wherein the first polarity is negative.

32. The method of claim 27, wherein the secondary material includes a polymer.

33. The method of claim 27, further comprising:
following application of the second charge, curing the secondary material.

34. The method of claim 32, wherein curing the secondary material includes heating the material to a predetermined temperature.

35. The method of claim 32, wherein curing the secondary material includes exposing the secondary material to a reactant.

36. The method of claim 35, wherein the reactant is configured to effect a chemical reaction between the secondary material and the reactant.

37. The method of claim 27, wherein the polymer includes at least one of polyvinylalanine, polystyrene, and polycarbonate.

38. The method of claim 27, wherein the secondary material includes at least one of a phosphate glass and a silicate glass.

39. A method for reinforcing a composite foam component, the method comprising:
providing a treatment mixture comprising a secondary material and a solvent; and
exposing a carbon foam material comprising a network of pores and a plurality of discontinuities to the treatment mixture, wherein exposing the carbon foam material to the treatment mixture effects a transfer of at least some of the secondary material to the carbon foam material such that the secondary material is selectively deposited on or within at least some of the plurality of discontinuities in an amount of about 0.5 percent by weight or greater and less than 25 percent by weight of the composite foam.

40. The method of claim 39, wherein the solvent includes a substantially non-polar substance.

41. The method of claim 39, wherein the solvent includes at least one of xylene and methylene chloride.

42. The method of claim 39, wherein the carbon foam material includes graphite foam.

43. The method of claim 39, wherein the secondary material includes a polymer.

44. The method of claim 43, wherein the polymer includes at least one of polyvinylalanine, polystyrene, and a polycarbonate.

45. The method of claim 39, wherein the secondary material includes at least one of a phosphate glass and a silicate glass.
